(19) United States
(12) Patent Application Publication
(10) Pub. No.: US 2012/0030380 A1
(43) Pub. Date: Feb. 2, 2012

(54) TRANSMISSION DEVICE, TRANSMISSION METHOD, AND CONTROL PROGRAM FOR TRANSMISSION DEVICE

(76) Inventor: Shigeyuki Yanagimachi, Tokyo (JP)

(21) Appl. No.: 13/263,862

(22) PCT Filed: Apr. 21, 2010
(86) PCT No.: PCT/JP2010/057521

§ 371 Date: Oct. 11, 2011

(30) Foreign Application Priority Data
Apr. 23, 2009 (JP) 2009-104749

(51) Int. Cl. G06F 3/00

(52) U.S. Cl. 710/15

(57) ABSTRACT

In a communication system using a parallel transmission, in order to provide a technology for an efficient transmission, a transmission device includes a data amount detection means for detecting a data amount of inputted data, a plurality of transmission means for transmitting the data in parallel, and a data allocation means for allocating the inputted data to the transmission means selected from the plurality of transmission means based on the data amount and a transmission capacity of the transmission means.

### TECHNICAL FIELD

The invention of the present application relates to a transmission device, a reception device, a communication system, a transmission method, a reception method, a computer-readable recording medium which records a control program for a transmission device, and a computer-readable recording medium which records a control program for a reception device which perform parallel transmission.

### BACKGROUND ART

As one example of a computer system, there is a configuration called a blade server in which one or more CPU (Central Processing Unit) cards are mounted in a chassis and a process is performed while all the CPUs cooperate with each other. An inter-CPU card cooperation process in the same chassis is performed by using an internal interface of the CPU via a switch card mounted in the same chassis. Communication for the inter-CPU card cooperation process is performed via a backplane of the chassis. The distance of the communication for the inter-CPU card cooperation process is about one meter. An inter-chassis CPU cooperation process is performed by connecting the switch cards with each other. A distance of inter-chassis communication is several meters to several tens of meters.

Parallel transmission using an optical fiber may be adopted for an application such as an inter-chassis communication whose transmission distance is relatively long. For example, a configuration of an optical transmission device in which the optical transmission blocks are connected to each other by using a plurality of optical fibers and data is transmitted in parallel is disclosed in patent document 1. A configuration of a system for transmitting a stream in parallel in which when congestion is detected on a network, the stream is divided and data of each stream is transmitted in series is disclosed in patent document 2.

In contrast, in the intra-chassis communication, the electrical transmission is mainly used. PCI (Peripheral Component Interconnect)-Express, Ethernet (registered trademark), or the like is widely used as an intra-chassis interface protocol and an inter-chassis interface protocol at present. The PCI-Express is a serial interface specification that was developed to get a high speed PCI bus, wherein the PCI bus is a parallel bus used for a personal computer or the like.

In the PCI-Express, data is transmitted on the serial bus. In the PCI-Express, a multi-lane configuration in which a plurality of transmission paths (lanes) are bundled together is adopted and transmission is performed in parallel. Accordingly, a transmission system to which the PCI-Express is applied is a parallel transmission system substantially.

Even in the intra-chassis communication in which the electrical transmission is mainly used, the use of the optical fiber transmission that is capable of large capacity transmission is being investigated in accordance with increase in transmission speed.

Further, in the PCI-Express, a control of a power supply is performed at a protocol level. A configuration in which in the PCI-Express, a control with which a supply of power to an electrical circuit in which no data flows is stopped is performed at the protocol level is disclosed in, for example, non-patent document 1.

FIG. 20 shows a state transition diagram of power management of the PCI-Express disclosed in non-patent document 1.In the PCI-Express, the following power supply states (power states) are defined. There are seven kinds of power states: “L0”, “L0s”, “L1”, “L2”, “L3”, “L2/L3 Ready”, and “LDn”. “L0” is a normal operation mode. “L0s” is a state in which all functions are in an ON state and “L0s” is a stand-by mode in which the mode can be immediately changed to the normal mode. “L1” is a stand-by mode in which a PLL (Phase Locked Loop) consuming a large amount of power is stopped. “L2” is a sleep mode in which a clock and a main power supply are stopped. “L3” is a mode in which the power supply is stopped. “L2/L3 Ready” is a mode that is in a state before shifting to “L2” or “L3”. “LDn” is in a state before shifting to “L0”. Thus, the PCI-Express specifies the function with which the low power consumption can be achieved at the protocol level.

An electric power control method conforming to the IEEE (Institute of Electrical and Electronic Engineers) 1394 standard that is a serial bus standard is disclosed in patent document 3. In the electric power control method described in patent document 3, a state of a device of which a physical layer is composed is changed from a normal operation state to a low power consumption state in a disconnect state and a suspend state. Specifically, by the IEEE 1394protocol, a mode of an optical transmitter and receiver is set to a low power consumption mode.

### PRIOR ART DOCUMENT

### Patent Document

[patent document 1] Japanese Patent Application Laid-Open No. 1996-293834 (paragraph [0036])

[patent document 2] Japanese Patent Application Laid-Open No. 2002-026986 (paragraph [0063])

[patent document 3] Japanese Patent Application Laid-Open No. 2002-118563 (paragraphs [0018] to [0020])

### Non-Patent Document

[non-patent document 1] “PCI-Express Base Specification Revision 1.1”, United States of America, PCI-SIG, Mar. 28, 2005, pages 231 to 272.

### DISCLOSURE OF THE INVENTION

### Technical Problem

However, the technology described in the above-mentioned patent documents 1 to 3 has a problem in which data cannot be efficiently transmitted.

The reason for this is that when the data is transmitted from a transmission side to a reception side by using a plurality of transmission paths in parallel, the data is not allocated to each transmission path according to an amount of data. For example, even when the data can be transmitted by using the smaller number of transmission paths from a result obtained by summing the amount of data transmitted in parallel, a case in which the more transmission paths than required are used occurs. As a result, use efficiency of the transmission path decreases.

An object of the present invention is to provide means for solving a problem that data transmission cannot be efficiently performed in a communication system using a parallel transmission.

### Technical Solution

A transmission device of the present invention includes data amount detection means for detecting a data amount of an inputted data, a plurality of transmission means for transmitting data in parallel, and data allocation means for allocating the inputted data to the transmission means selected from the plurality of transmission means based on the data amount and the transmission capacity of the transmission means.

A transmission method of the present invention includes the steps of: detecting a data amount for detecting the data amount of inputted data, allocating the data to transmission means selected from a plurality of transmission means based on the data amount and a transmission capacity of the transmission means, and transmitting the inputted data in parallel by using the selected transmission means.

A computer-readable recording medium for recording a control program for a transmission device of the present invention that allows the transmission device to operate as data amount detection means for detecting a data amount of inputted data, a plurality of transmission means for transmitting the data in parallel, and data allocation means for allocating the inputted data to the transmission means selected from the plurality of transmission means based on the data amount and a transmission capacity of the transmission means.

### Advantageous Effect of the Invention

The present invention has an advantage of making possible an efficient transmission in a communication system using a parallel transmission.

### BRIEF DESCRIPTION OF THE DRAWINGS

FIG. 1 is a figure showing a configuration of a transmission process section and a reception process section in a first exemplary embodiment.

FIG. 2 is a front view of an intra-chassis optical communication system of a first exemplary embodiment.

FIG. 3 is a cross-sectional side view of a chassis showing a mounting state of a CPU card and a switch card that are mounted in the chassis in a first exemplary embodiment.

FIG. 4 is a front view of an optical backplane and an electrical backplane used in an intra-chassis communication system of a first exemplary embodiment.

FIG. 5 is a functional block diagram of an intra-chassis optical communication system of a first exemplary embodiment.

FIG. 6 is a figure showing a structure of an Ethernet packet.

FIG. 7 is a flowchart showing operation of a transmission process section of a first exemplary embodiment.

FIG. 8 is a figure showing a flow of an Ethernet packet when all transmission paths use all bands.

FIG. 9 is a figure showing a flow of an Ethernet packet when all transmission paths use only a part of all bands of a transmission path.

FIG. 10 is a figure showing operation when an Ethernet packet is allocated by data allocation means.

FIG. 11 is a flowchart showing operation of a reception process section of a first exemplary embodiment.

FIG. 12 is a figure showing a configuration of a transmission process section and a reception process section of a second exemplary embodiment.

FIG. 13 is a figure showing a packet format of PCI-Express.

FIG. 14 is a flowchart showing operation of a transmission process section of a second exemplary embodiment.

FIG. 15 is a flowchart showing operation of a reception process section of a second exemplary embodiment.

FIG. 16 is a figure showing a configuration of a transmission device of a third exemplary embodiment.

FIG. 17 is a flowchart showing operation of a transmission device of a third exemplary embodiment.

FIG. 18 is a figure showing a configuration of a communication system of a fourth exemplary embodiment.

FIG. 19 is a flowchart showing operation of a reception device in a communication system of a fourth exemplary embodiment.

FIG. 20 is a state transition diagram of a power management of PCI-Express.

### BEST MODE FOR CARRYING OUT THE INVENTION

### First Exemplary Embodiment

A first exemplary embodiment of the present invention will be described in detail with reference to the drawings.

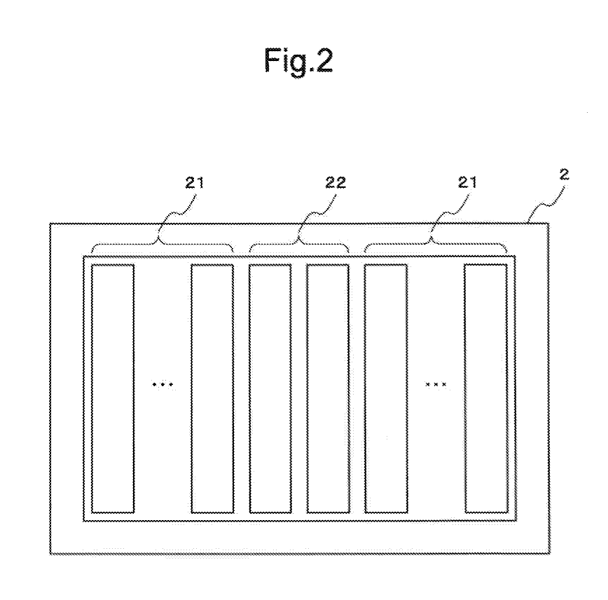

In the first exemplary embodiment, a communication system of the present invention is applied to an intra-chassis optical communication system. FIG. 2 is a front view of an intra-chassis optical communication system 200 of the first exemplary embodiment. The intra-chassis optical communication system 200 includes a chassis 2, one or more CPU cards 21, and one or more switch cards 22. The CPU card 21 and the switch card 22 are mounted in the chassis 2.

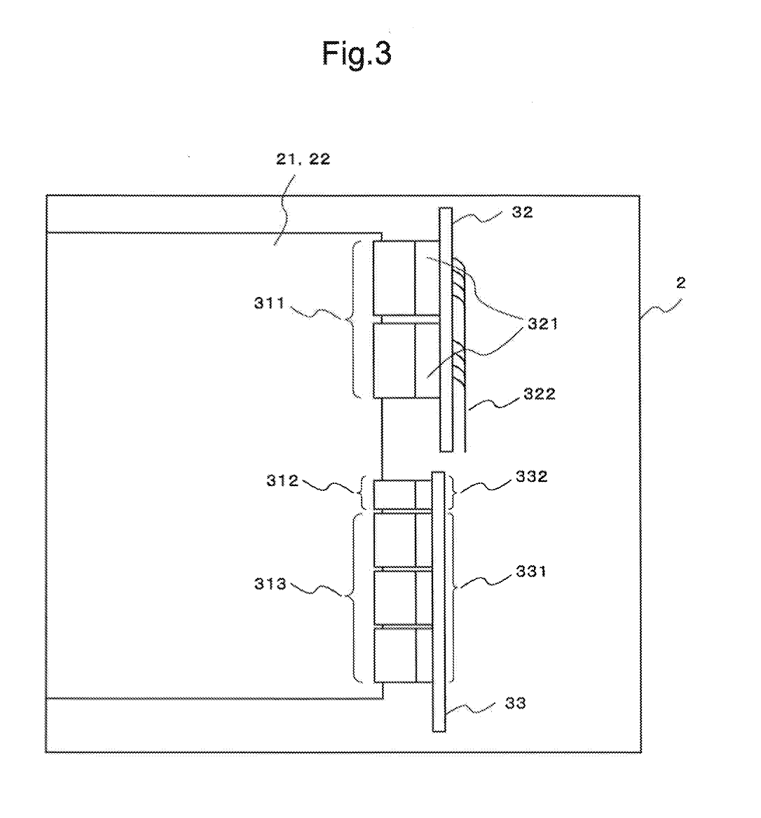

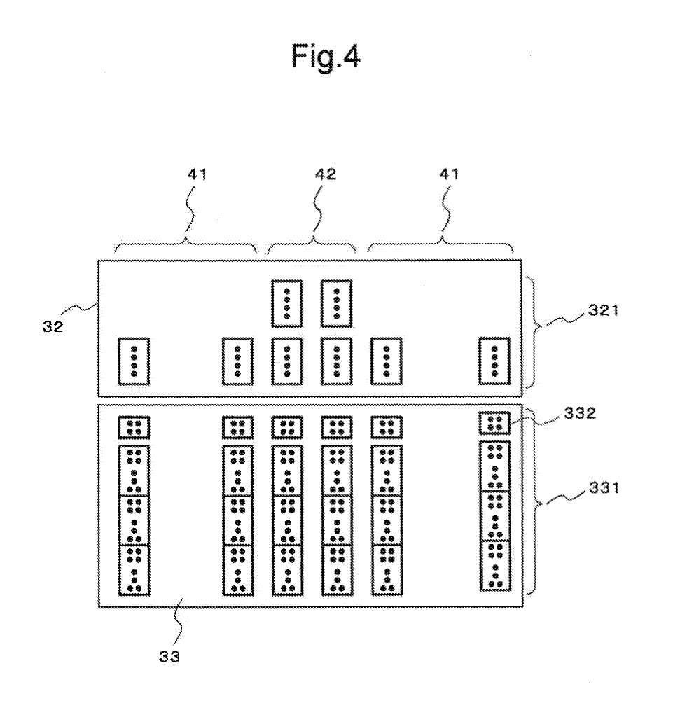

Next, the internal structure of the chassis 2 will be described by using FIG. 3 and FIG. 4. FIG. 3 is a cross-sectional side view of the chassis 2 showing a mounting state of the CPU card 21 and the switch card 22 that are mounted in the chassis 2 in the first exemplary embodiment. Here, a method for mounting the switch card 22 in the chassis 2 is the same as a method for mounting the CPU card 21. Accordingly, in FIG. 3, the CPU card 21 and the switch card 22 are drawn in common. In the CPU card 21 and the switch card 22, one or more optical connectors 311, one or more power supply connectors 312, and one or more electrical connectors 313 are mounted. An optical backplane 32 and an electrical backplane 33 are mounted in the chassis 2.

One or more optical connectors 321 are mounted on the optical backplane 32 so that the optical connector 321 faces the optical connector 311 on the CPU card 21 and the switch card 22.

One or more power supply connectors 332 and one or more electrical connectors 331 are mounted on the electrical backplane 33 so that the power supply connector 332 and the electrical connector 331 face the power supply connector 312 and the electrical connector 313 on the CPU card 21 and the switch card 22, respectively.

When the CPU card 21 and the switch card 22 are installed in the chassis 2, the optical connector 311 engages with the optical connector 321, the power supply connector 312 engages with the power supply connector 332, and the electrical connector 313 engages with the electrical connector 331. Each slot is connected to each other through an optical fiber 322 connected to the optical connector 321 mounted on the optical backplane 32. Further, an electrical wiring pattern (not shown) is provided on the electrical backplane 33. The slot is electrically connected to each other also by this wiring pattern.

In the first exemplary embodiment, transfer of a large volume of main signal data or high speed transfer of main signal data in the CPU card 21 and the switch card 22 is performed by an optical transmission via the optical connectors 311 and 321. Low speed data transmission or small volume data transmission for managing the intra-chassis communication system is performed by electrical transmission via the electrical connectors 313 and 331. Additionally, the supply of the power to the CPU card 21 and the switch card 22 from the chassis 2 is performed via the power supply connectors 312 and 332.

FIG. 4 is a front view of the optical backplane 32 and the electrical backplane 33 used in the intra-chassis optical communication system 200 of the first exemplary embodiment. The CPU card 21 is inserted into a CPU card slot 41 and the switch card 22 is inserted into a switch card slot 42. As a result, as shown in FIG. 3, the optical connector 311 engages with the optical connector 321, the power supply connector 312 engages with the power supply connector 332, and the electrical connector 313 engages with the electrical connector 331.

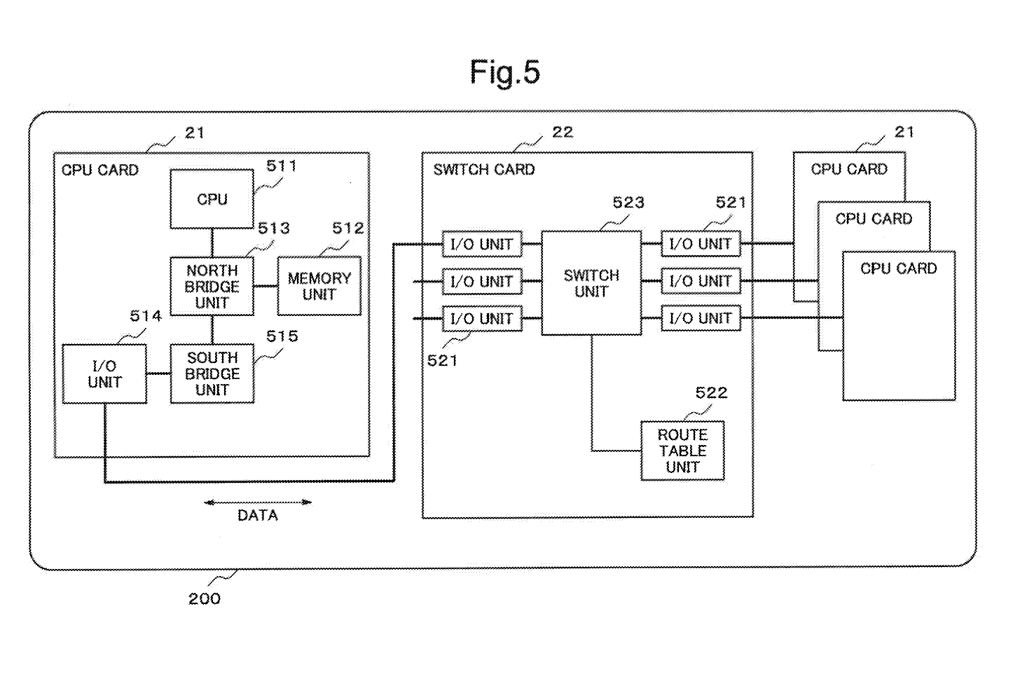

Next, a functional configuration of the intra-chassis optical communication system 200 of the first exemplary embodiment will be described. FIG. 5 is a functional block diagram of the intra-chassis optical communication system 200 of the first exemplary embodiment.

The CPU card 21 in the intra-chassis optical communication system 200 includes a CPU 511, a memory unit 512, a north bridge unit 513, an I/O (Input/Output) unit 514, and a south bridge unit 515.

The CPU 511 performs a calculation process. The north bridge unit 513 connects a device having a high speed bus such as the memory unit 512 or the like to the CPU 511. The south bridge unit 515 connects a device having a low speed bus such as the I/O unit 514 or the like to the CPU 511 via the north bridge unit 513.

The switch card 22 in the intra-chassis optical communication system 200 includes an I/O unit 521, a route table unit 522, and a switch unit 523.

The I/O unit 521 receives data from the CPU card 21 and transfers the data to the port of the connected switch unit 523. The I/O unit 521 receives the data transferred from the port of the switch unit 523 and outputs it outside.

The route table unit 522 holds a corresponding relationship between an address of each CPU card 21 and the port of the switch unit 523 connected to the CPU card.

The switch unit 523 of the switch card 22 is connected to the I/O unit 521. The switch unit 523 reads out the address of the CPU card that is a destination of the data from the data inputted to a port of the switch unit 523. The switch unit 523 connects the ports of the switch unit 523 so that the data is transferred to the CPU card that is the destination based on information of the route table unit 522. By this way, the CPU cards 21 are connected to each other via the switch card 22.

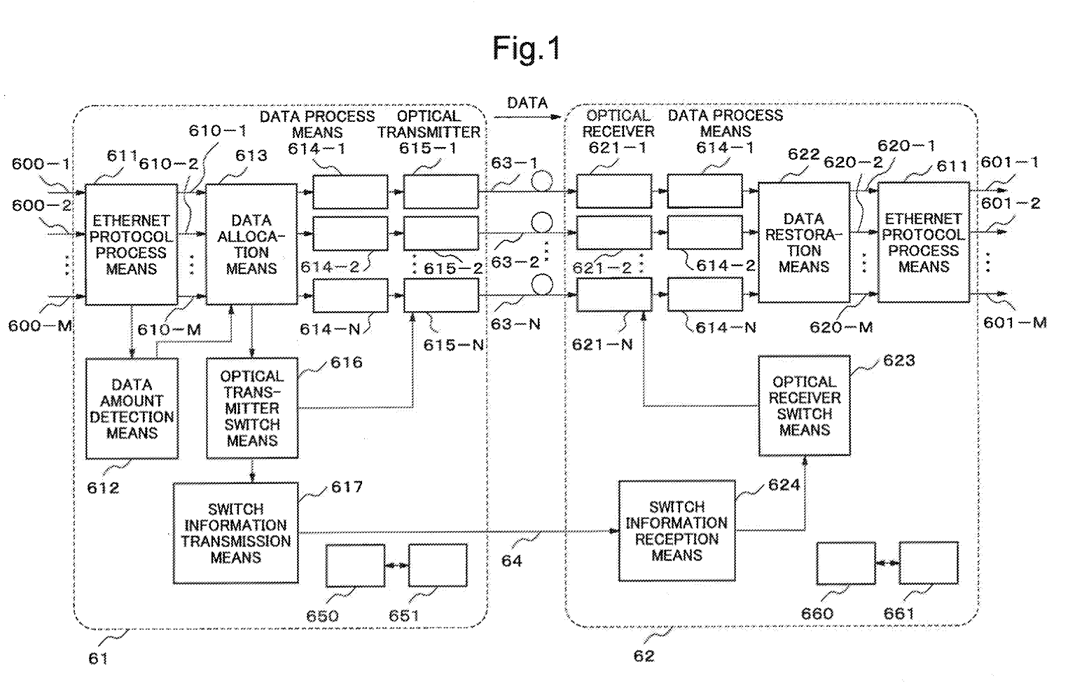

Next, a configuration of an optical transmission system of the first exemplary embodiment will be described. FIG. 1 is a block diagram of a transmission process section 61 and a reception process section 62 of the first exemplary embodiment that are mounted on the I/O unit 514 of the CPU card 21 and the I/O unit 521 of the switch card 22 that are shown in FIG. 5. In FIG. 1, the transmission process section 61 and the reception process section 62 are connected by N+1 transmission paths in parallel: N transmission paths 63-1 to 63-N and a transmission path 64. FIG. 1 shows a configuration in only a direction from the transmission process section 61 to the reception process section 62. However, because the I/O unit 521 is a bidirectional interface, actually, the I/O unit 521 has both functions of the transmission process section 61 and the reception process section 62 shown in FIG. 1.

In an OSI (Open System Interconnection) reference model, the function of the protocol is represented as a hierarchical model in order to interconnect a plurality of computers. The OSI Reference Model defines seven layers from an application layer (layer 7) in which an application such as an e-mail, a file transfer, or the like operates to a physical layer (layer 1) in which a specification of an electrical signal and an optical signal is defined.

The first exemplary embodiment of the present invention relates to a data link layer which defines a communication method for inter-CPU card data transmission on the Ethernet or the like and a physical layer in which a conversion into a bit string signal suitable for an encoding and a transmission medium is performed. The data link layer is the layer 2 of the OSI Reference Model that is related to the interconnection of the computers. The physical layer is the layer 1 of the OSI Reference Model. In FIG. 1, only the functions related to the layer 2 and the layer 1 are shown and the other layers are not shown.

In the first exemplary embodiment, although it is assumed that the protocol of the data link layer is the Ethernet, the protocol of the data link layer is not limited to a specific protocol.

First, the configuration of the transmission process section 61 will be described. The transmission process section 61 shown in FIG. 1 includes an Ethernet protocol process means 611, a data amount detection means 612, a data allocation means 613, N data process means 614-1 to 614-N, N optical transmitters 615-1 to 615-N, an optical transmitter switch means 616, a switch information transmission means 617, a CPU 650, and a memory 651. Here, N is a natural number of two or more.

The Ethernet protocol process means 611 performs an Ethernet protocol process. Namely, in the transmission process section 61, the Ethernet protocol process means 611 packetizes data inputted from M data input paths 600-1 to 600-M into the Ethernet packets and outputs them to wiring paths 610-1 to 610-M, respectively. In the reception process section 62, the Ethernet protocol process means 611 extracts the received data from the Ethernet packets inputted from wiring paths 620-1 to 620-M and output them to M data output paths 601-1 to 601-M. Here, M is a natural number.

The data amount detection means 612 detects an amount of data flowing in the Ethernet protocol process means 611.

The data allocation means 613 allocate the data to the optical transmitters 615-1 to 615-N based on the data amount detected by the data amount detection means 612 and the transmission capacity of the optical transmitters 615-1 to 615-N.

The data process means 614-1 to 614-N perform a process such as an encodings or the like to the data from the data allocation means 613.

The optical transmitters 615-1 to 615-N convert the electrical signal received from the data process means 614-1 to 614-N into the optical signal.

The optical transmitter switch means 616 controls a power supply of the optical transmitters 615-1 to 615-N based on the usage status of the optical transmitter that is inputted from the data allocation means 613 and output power supply control information including information about the usage status to the switch information transmission means 617.

The switch information transmission means 617 transmits the power supply control information inputted from the optical transmitter switch means 616 to the reception process section 62 through the transmission path 64.

The CPU 650 reads out a program stored in the memory 651 and controls each block of the transmission process section 61.

On the other hand, the reception process section 62 includes N optical receivers 621-1 to 621-N, N data process means 614-1 to 614-N, a data restoration means 622, The Ethernet protocol process means 611, optical receiver switch means 623, a CPU 660, and a memory 661.

The optical receivers 621-1 to 621-N receive the optical signal from the optical transmission paths 63-1 to 63-N and convert it into the electrical signal.

The data process means 614-1 to 614-N convert the electrical signal outputted by the optical receivers 621-1 to 621-N into the data of the Ethernet protocol.

The data restoration means 622 performs a process of the data outputted by the data process means 614-1 to 614-N of the reception process section 62 and outputs the data to the Ethernet protocol process means 611 in a form which is the same as that of the data inputted to the data allocation means 613 in the transmission process section 61. The operation of the data restoration means 622 will be described in detail later.

The Ethernet protocol process means 611 of the reception process section 62 performs the Ethernet protocol process to the Ethernet data outputted from the data restoration means 622 to the wiring paths 620-1 to 620-M and outputs the processed data to the data output paths 601-1 to 601-M.

The optical receiver switch means 623 controls a power supply of the optical receivers 621-1 to 621-N based on the power supply control information.

The CPU 660 reads out a program stored in the memory 661 and controls each block of the reception process section 62.

### Explanation of Operation of First Exemplary Embodiment

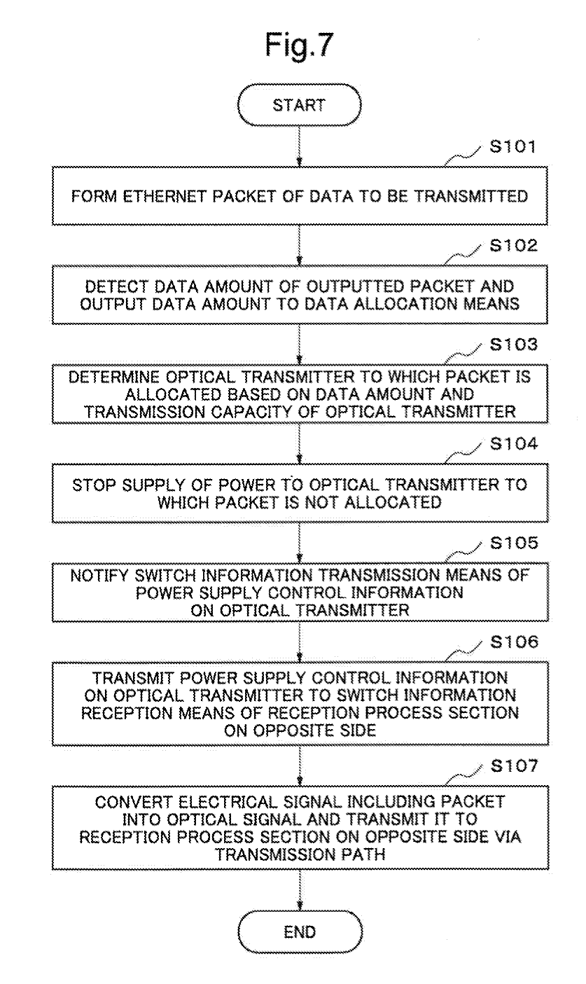

The operation of the first exemplary embodiment will be described by using the drawings explained above and FIGS. 7 to 11.

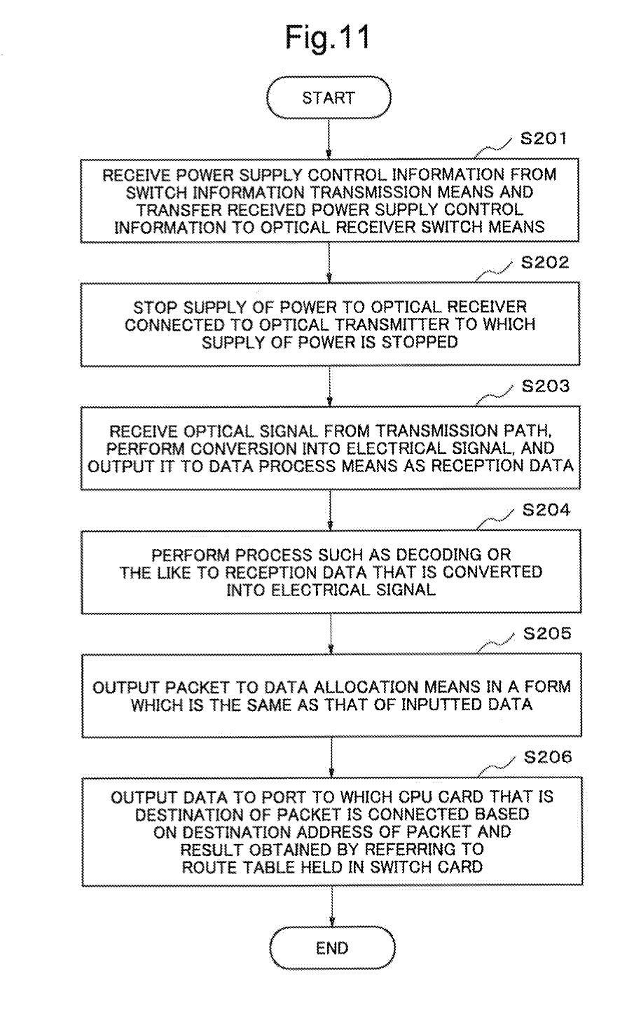

FIG. 7 and FIG. 11 are flowcharts showing the operation of the transmission process section 61 and the reception process section 62, respectively.

First, the operation of the transmission process section 61 will be described. Further, in the following explanation, it is assumed that the transmission process section 61 is provided at a CPU card 21 side and the reception process section 62 is provided at a switch card 22 side. The operation when the data is transferred from the CPU card 21 to the switch card 22 will be described. Further, even when it is assumed that the transmission process section 61 is provided at the switch card 22 side and the reception to process section is provided at the CPU card 21 side, the following explanation can be applied.

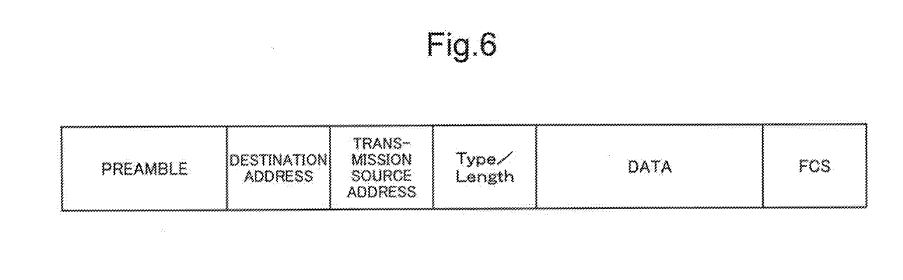

The data to be transmitted is inputted to the Ethernet protocol process means 611 from the data input paths 600-1 to 600-M. The Ethernet protocol process means 611 of the transmission process section 61 adds header information such as a destination address, a transmission source address, a frame length, and the like to the data to be transmitted. A FCS (Frame Check Sequence) for checking whether a bit change occurs during data transfer is added to the end of the data to be transmitted. As a result, the Ethernet packet as shown in FIG. 6 is formed (step S101 in FIG. 7).

Next, the data amount detection means 612 detects the data amount of the packet outputted by the Ethernet protocol process means 611 and outputs the detected data amount to the data allocation means 613 (step S102).

The data allocation means 613 determines the optical transmitter among the optical transmitters 615-1 to 615-N to which the packet inputted from the wiring paths 610-1 to 610-M is allocated based on the detected data amount and the transmission capacity of the optical transmitters 615-1 to 615-N (S103).

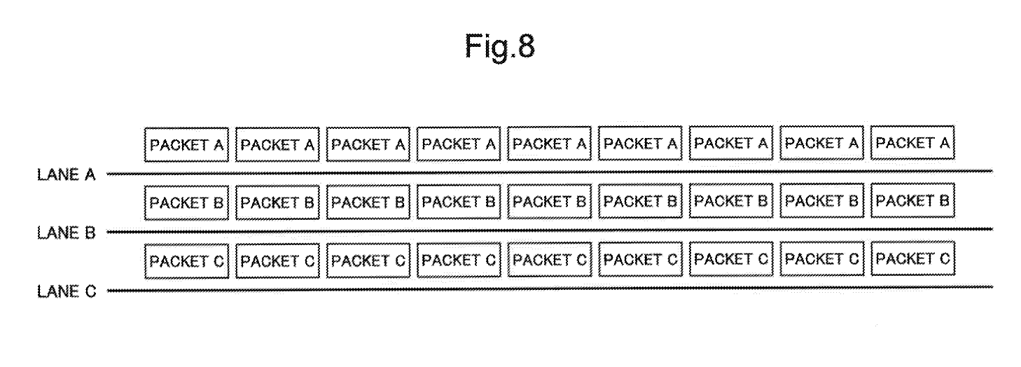

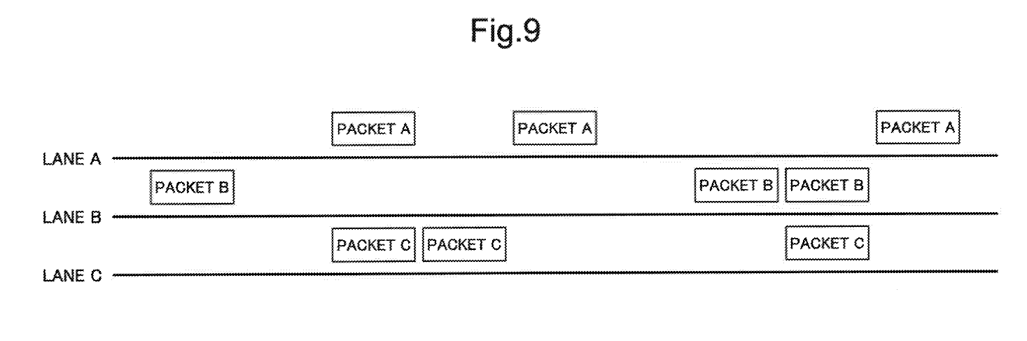

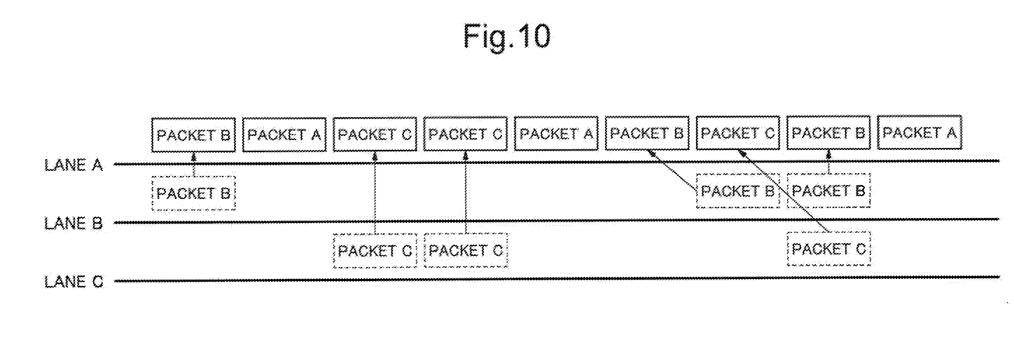

Here, the data allocation operation of the data allocation means 613 in the first exemplary embodiment will be described by using FIGS. 8 to 10. FIG. 8 is a figure showing a flow of the packet when the data uses all bands of all the transmission paths. FIG. 9 is a figure showing a flow of the packet when the data uses only the part of the band of the transmission path. FIG. 10 is a figure showing the operation when the data allocation means 613 allocates all the packets to a lane A. The packet A, B, or C is a packet into which the data is encapsulated and which is inputted from any one of the data input paths 600-1 to 600-M, wherein the data input path of the packet A, B, or C is different from each other. Further, in FIGS. 8 to 10, a case in which the optical transmission paths 63-1 to 63-N shown in FIG. 1 have three parallel transmission paths (lanes A, B, and C) will be described as an example. In FIGS. 8 to 10, the lanes A, B, and C correspond to the optical transmission paths 63-1, 63-2, and 63-3 shown in FIG. 1, respectively. Even when there are two or four or more lanes, the data allocation means 613 allocates the data to the respective lanes by using the same procedure.

In the first exemplary embodiment, the data allocation means 613 allocates the packet to be transmitted to the optical transmitters 615-1 to 615-N according to the data transmission amount and the transmission capacity of the optical transmitter which transmits the data to the lane so that the packet is transmitted by using the smaller number of lanes through consolidation of the lanes.

For example, when the total transmission amount of data transmitted by the lane B and lane C is equal to or smaller than a residual transmission capacity of the lane A, the data allocation means 613 can allocate the packets that flow in the lane B and the lane C to the lane A for transmission. This is shown in FIG. 9 and FIG. 10. Generally, in the parallel transmission system, as shown in FIG. 9, packets with different destination addresses are allocated to different lanes and are transmitted. In contrast, in the first exemplary embodiment, as shown in FIG. 10, the data allocation means 613 allocates the packets in the lane B and the lane C to the lane A by using an unused band of the lane A so that the packets are transmitted by the lane A through consolidation of the lanes.

Here, the explanation returns to the flowchart shown in FIG. 7, optical output block switch means 616 controls a power supply of the optical transmitters 615-1 to 615-N based on the optical transmitter usage situation received from the data allocation means 613. Namely, the optical output block switch means 616 generates power supply control information on each of the optical transmitters 615-1 to 615-N. The optical transmitter switch means 616 stops the supply of the power to the optical transmitter to which the packet is not allocated based on the generated power supply control information (step S104). For example, when the allocation shown in FIG. 10 is performed, the optical transmitter switch means 616 stops the supply of the power to the optical transmitters 615-2 and 615-3 connected to the lane B and lane C. The optical transmitter switch means 616 notifies the switch information transmission means 617 of the power supply control information on each of the optical transmitters 615-1 to 615-N (step S105). The power supply control information includes information on whether the power is supplied to each of the optical transmitters 615-1 to 615-N or whether the supply of the power is stopped. The switch information transmission means 617 transmit the power supply control information on each optical transmitter 615 to switch information reception means 624 of the reception process section 62 on an opposite side via the transmission path 64 (step S106).

After a process such as an encoding or the like is performed by the data process means 614 to the packet transmitted from the data allocation means 613 of the transmission process section 61, the packet is transmitted to the optical transmitters 615-1 to 615-N. The optical transmitters 615-1 to 615-N convert the electrical signal into the optical signal with respect to the encoded packet and transmit it to the reception process section 62 on the opposite side via the optical transmission paths 63-1 to 63-N (step S107).

Further, the operation of transmitting the Ethernet packet to the optical transmission paths 63-1 to 63-N (step S107) can be performed at any timing in the process from step S104 to step S106 after the optical transmission path by which the packet is transmitted has been determined (step S103).

Next, the operation of the reception process section 62 will be described by using FIG. 11.

The switch information reception means 624 receives the power supply control information from the switch information transmission means 617 via the transmission path 64. The received power supply control information is transferred to the optical receiver switch means 623 (step S201).

The optical receiver switch means 623 stops the supply of the power to the optical receiver connected to the optical transmitter to which the supply of the power is stopped based on the power supply control information on each of the optical transmitters 615-1 to 615-N (step S202). For example, in FIG. 10, all the packets are allocated to the lane A. Here, when it is assumed that the lanes A, B, and C correspond to the optical transmission paths 63-1, 63-2 and 63-3 shown in FIG. 1, respectively, the supply of the power to the optical transmitters 615-2 and 615-3 is stopped in the transmission process section 61. Accordingly, optical receiver switch means 623 stops the supply of the power to the optical receivers 621-2 and 621-3 connected to the lane B and the lane C.

In the reception process section 62, the optical receivers 621-1 to 621-N receive the optical signals from the optical transmission paths 63-1 to 63-N, perform conversion into the electrical signal, and output them to the data process means 614 as reception data (step S203). The data process means 614 performs a process such as a decoding or the like to the reception data that is converted into the electrical signal (step S204). The data process means 614 transmits the processed reception data to data restoration means 622.

The operation of the data restoration means 622 will be described below.

For example, in case of M=1, the input path to the data allocation means 613 is only the wiring path 610-1. In this case, the data inputted to the data allocation means 613 from the wiring path 610-1 is allocated to the optical transmitters 615-1 to 615-N. In the data restoration means 622, the inputted reception data is outputted to only the wiring path 620-1.

In case of M=N, the input paths to the data allocation means 613 are N wiring paths 610-1 to 610-N. In this case, the data inputted to the data allocation means 613 from the wiring paths 610-1 to 610-N is allocated to the optical transmitters 615-1 to 615-N. In the data restoration means 622, the inputted reception data is outputted from the wiring paths 620-1 to 620-N. Here, the data outputted to the wiring paths 620-1 to 620-N correspond to the data inputted from the wiring paths 610-1 to 610-N, respectively.

In case of M≠1 and M≠N, like the case of M=1 or M=N mentioned above, the data restoration means 622 outputs the data inputted from the wiring paths 610-1 to 610-M to the wiring paths 620-1 to 620-M, respectively.

Thus, the data restoration means 622 outputs the packet allocated to one or more lanes at the output of the data allocation means 613 in a state before allocation, namely, in a form which is the same as that of the data inputted to the data allocation means 613 (step S205). Namely, a content of the data outputted from the data restoration means 622 is the same as a content of the data inputted to the data allocation means 613 in the transmission process section 61.

An error check by the FCS, a check of the destination address, or the like is performed by the Ethernet protocol means 611 with respect to the Ethernet packet outputted from the data restoration means 622. The switch unit 523 outputs the data to a port to which the CPU card 21 that is a destination of the packet is connected based on the destination address of the packet and a result obtained by referring to the route table 522 held in the switch card 22 (step S206). The switch card 22 transmits the data to the CPU card 21 from the port to which the CPU card 21 that is the destination of the data is connected.

Because a transmission process of the data in the switch card 22 and a reception process of the data in the CPU card 21 that is the destination of the data are the same as the process from step 101 to step 107 shown in FIG. 7 and the process from step 201 to step 205 shown in FIG. 11, the description will be omitted.

Further, the order of the operation (step S201 to step S202) in which the supply of the power to the optical receiver is stopped and the operation (step S203 to step S206) in which the data is received from the transmission path and it is processed may be changed based on the received power supply control information.

As described above, in the first exemplary embodiment, the data allocation means 613 allocates the data so that the data packet transmitted over the plurality of lanes is transmitted by using the smaller number of lanes by utilizing the unused capacity of the lane. The supply of the power to the optical transmitter of the unused lane is stopped. The optical receiver switch means 623 of the reception process section 62 stops the supply of the power to the optical receiver facing the optical transmitter to which the supply of the power is stopped based on the power supply control information on each of the optical transmitters 615-1 to 615-N that is received from the transmission process section 61.

Namely, when the total transmission amount of data of one transmission path is equal to or smaller than a residual of the transmission capacity of the other transmission path, the intra-chassis optical communication system of the first exemplary embodiment of the present invention allocates the data of those transmission paths so that the data is transmitted by the other transmission path.

As a result, the intra-chassis optical communication system of the first exemplary embodiment can transmit the data by using the smaller number of transmission paths and the efficient data transmission in the optical communication system using a parallel transmission can be achieved.

Further, the intra-chassis optical communication system of the first exemplary embodiment of the present invention stops the supply of the power to the unused optical transmitter and the unused optical receiver.

As a result, the intra-chassis optical communication system of the first exemplary embodiment of the present invention has advantage that a power consumption corresponding to the power consumption of the optical transmitter and the optical receiver that are stopped can be reduced.

Further, in the first exemplary embodiment, all the packets that flow in the lanes A, B, and C shown in FIG. 9 are transmitted by the lane A as shown in FIG. 10. However, when all the data is transmitted by using only the lane A, if the transmission capacity of the optical transmitter 615-1 connected to the lane A is insufficient, another lane may be additionally used to transmit the packet. For example, the packets flowing in three lanes: the lane A, the lane B, and the lane C, may be transmitted by using two lanes: the lane A and the lane B. In this modification example, the lane C is not used for the data transmission. Accordingly, in this modification example, by stopping the supply of the power to the optical transmitter and the optical receiver of the lane C, the power consumption of the intra-chassis optical communication system can be reduced like the first exemplary embodiment.

In the first exemplary embodiment, the supply of the power to the unused optical transmitter among the unused optical transmitters 615-1 to 615-N is stopped. However, for example, a drive current of the light emitting element of the unused optical transmitter may be stopped. In this case, the electric power consumed by the light emitting element of the unused optical transmitter can be reduced.

Further, the operation described in the flowchart explained in FIG. 7 and FIG. 11 to may be controlled by the CPU 650 included in the transmission process section 61 or the CPU 660 included in the reception process section 62 by using a program.

### Second Exemplary Embodiment

Next, a second exemplary embodiment of the present invention will be described in detail with reference to the drawing.

The second exemplary embodiment is an intra-chassis optical communication system and in the I/O unit 514 in the first exemplary embodiment, the PCI-Express is used for the higher rank protocol. The external appearance and the configuration of the intra-chassis optical communication system of the second exemplary embodiment, the configuration of the switch card, and the configuration of the CPU card are the same as those of the first exemplary embodiment.

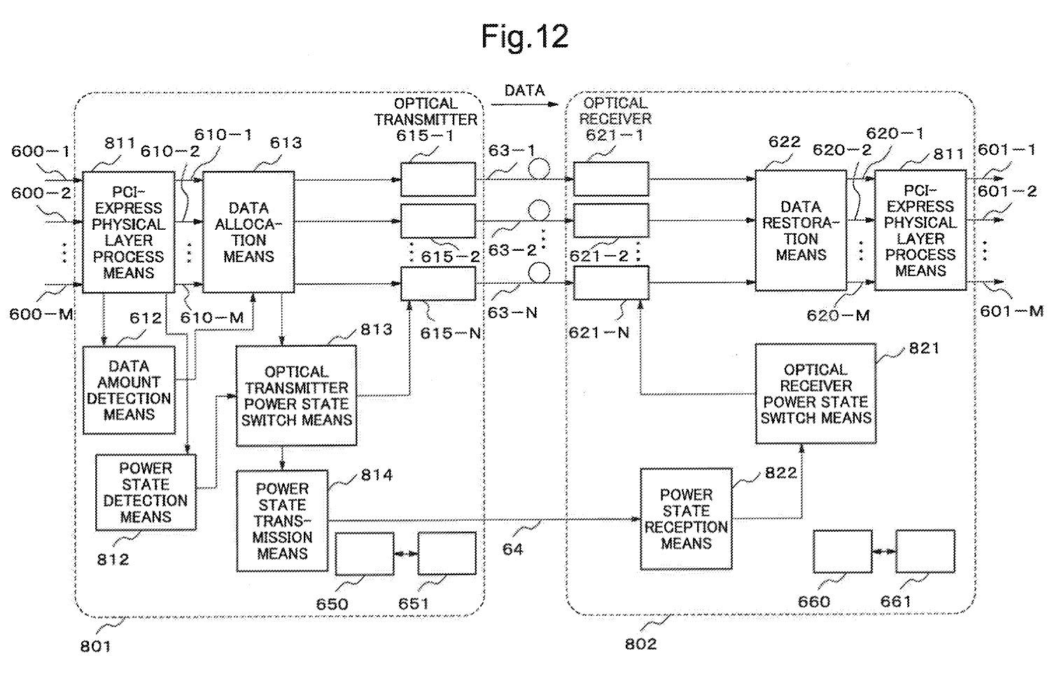

FIG. 12 shows a configuration of a transmission process section 801 and a reception process section 802 mounted on an I/O unit 514 of the CPU card 21 and an I/O unit 521 of the switch card 22 of the second exemplary embodiment of the invention of the present application. FIG. 12 shows a configuration in only a direction from the transmission process section 801 to the reception process section 802. In contrast, because the I/O unit 521 is a bidirectional interface, actually, the I/O unit 521 has both functions of the transmission process section 61 and the reception process section 62 shown in FIG. 1.

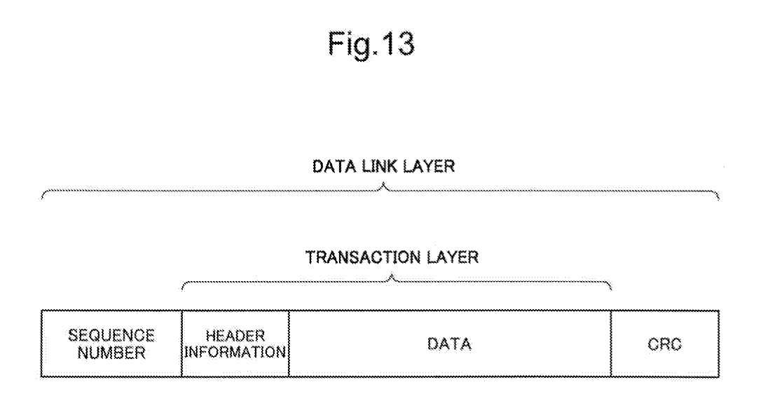

FIG. 13 is a figure showing a packet format of the PCI-Express. The PCI-Express has three layers: a transaction layer, a link layer, and a physical layer. Further, FIG. 13 shows only the transaction layer and the link layer that are related to the present invention.

The transaction layer performs a flow control of the transmitted data in order to avoid loss of the transmission data due to buffer overflow or the like at the destination. The link layer performs link management, error detection, and error correction. The physical layer performs a physical transmission such as serial to parallel conversion, a PLL function, or the like.

First, a configuration of the transmission process section 801 of the optical transmission system in the second exemplary embodiment shown in FIG. 12 will be described. The transmission process section 801 includes PCI-Express physical layer process means 811, the data amount detection means 612, the data allocation means 613, the N optical transmitters 615-1 to 615-N, a power state detection means 812, an optical transmitter power state switch means 813, a power state transmission means 814, the CPU 650, and the memory 651. Here, N is a natural number of two or more.

The PCI-Express physical layer process means 811 performs a process in which the data inputted from the data input paths 600-1 to 600-M is packetized into the PCI-Express packet or a process in which the received data is extracted from the PCI-Express packet. In the transmission process section 801, the PCI-Express physical layer process means 811 packetizes the inputted data into the PCI-Express packet and outputs it to the wiring paths 610-1 to 610-M. The data amount detection means 612 detects an amount of data flowing in the PCI-Express physical layer process means 811. Here, M is a natural number.

The data allocation means 613 allocates the data inputted from the wiring paths 610-1 to 610-M to the optical transmitters 615-1 to 615-N based on the data amount detected by the data amount detection means 612 and the transmission capacity of the optical transmitters 615-1 to 615-N. The data allocation means 613 transmits allocation information to the optical transmitter power state switch means 813.

The power state detection means 812 acquires the PCI-Express power state from the data passing through the PCI-Express physical layer process means 811 and transmits the acquired power state to the optical transmitter power state switch means 813.

The optical transmitters 615-1 to 615-N are connected to one end of each transmission path of the N optical transmission paths 63-1 to 63-N. The optical transmitters 615-1 to 615-N convert the electrical signal outputted by the data allocation means 613 into the optical signal.

The optical transmitter power state switch means 813 performs a power supply control of the optical output of the optical transmitters 615-1 to 615-N based on the allocation information from the data allocation means 613 and the power state from the power state detection means 812.

The power state transmission means 814 transmits the power supply control information on the optical transmitters 615-1 to 615-N that is outputted by the optical transmitter power state switch means 813 to the reception process section 802. The power supply control information includes information of data allocation to the optical transmitters 615-1 to 615-N and the power state detected from the PCI-Express.

The CPU 650 reads out a program stored in the memory 651 and controls each block of the transmission process section 801.

On the other hand, the reception process section 802 includes the N optical receivers 621-1 to 621-N, the data restoration means 622, the PCI-Express physical layer process means 811, an optical receiver power state switch means 821, a power state reception means 822, the CPU 660, and the memory 661.

The optical transmission paths 63-1 to 63-N are the optical transmission paths in which a plurality of transmission paths are arranged in parallel. At both the ends of the transmission paths arranged in parallel, the optical transmitters 615-1 to 615-N and the optical receivers 621-1 to 621-N are connected.

The optical receivers 621-1 to 621-N are connected to the other end of the optical transmission paths 63-1 to 63-N, respectively. The optical receivers 621-1 to 621-N convert the optical signal received from the optical transmission paths 63-1 to 63-N into the electrical signal.

The data restoration means 622 performs a process of the reception data inputted from the optical receivers 621-1 to 621-N and outputs it to the wiring paths 620-1 to 620-M in a form which is the same as that of the data inputted to the data allocation means 613 in the transmission process section 801.

The PCI-Express physical layer process means 811 receives the packet outputted by the data restoration means 622 from the wiring paths 620-1 to 620-M and performs a process of the PCI-Express physical layer. The PCI-Express physical layer process means 811 outputs the packet to which the process of the PCI-Express physical layer is performed to the data output paths 601-1 to 601-M.

The power state reception means 822 receives the power supply control information from the power state transmission means 814 and outputs it to the optical receiver power state switch means 821.

The optical receiver power state switch means 821 controls the power supply of the optical receivers 621-1 to 621-N based on the data allocation information and the power state that are included in the power supply control information received from the power state transmission means 814 of the transmission process section 801.

The CPU 660 reads out a program stored in the memory 661 and controls each block of the reception process section 802.

### Explanation of Operation of Second Exemplary Embodiment

Next, the operation of the second exemplary embodiment will be described. In the following explanation, it is assumed that the transmission process section 801 is provided at the CPU card 21 side and the reception process section 802 is provided at the switch card 22. The operation when the data is transferred from the CPU card 21 to the switch card 22 will be described. However, even when it is assumed that the transmission process section 801 is provided at the switch card 22 side and the reception process section 802 is provided at the CPU card 21 side, the following explanation can be applied.

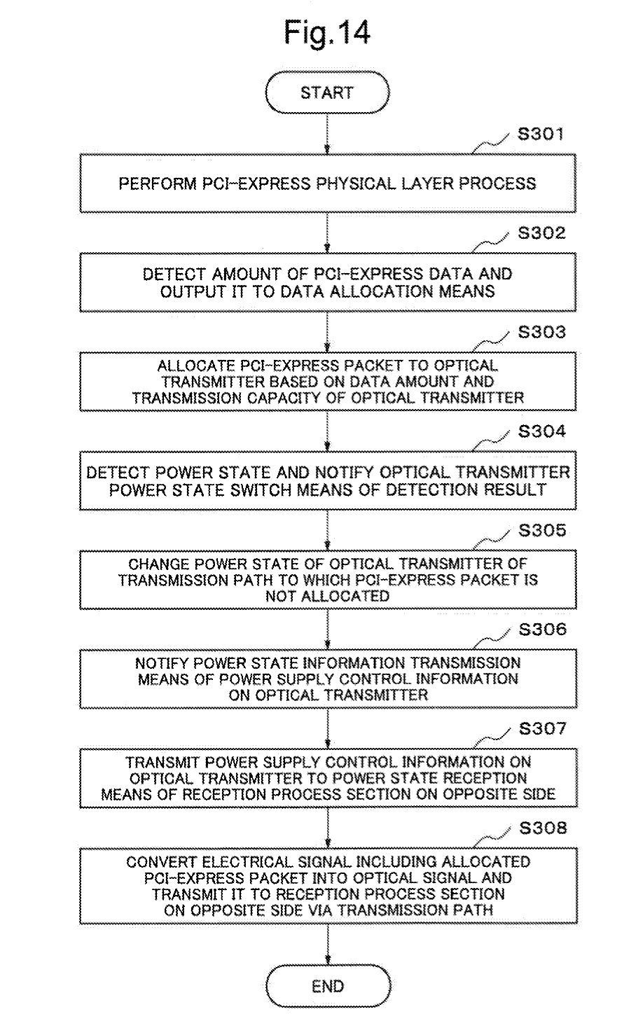

First, the operation of the transmission process section 801 will be described. FIG. 14 is a flowchart showing the Operation of the transmission process section 801 of the second exemplary embodiment.

First, the PCI-Express physical layer process means 811 in the I/O unit 514 of the CPU card 21 performs a physical layer process such as serial to parallel conversion, a PLL process, or the like to the data inputted from the data input paths 600-1 to 600-M (step S301).

Next, the data amount detection means 612 detects an amount of PCI-Express data generated by the PCI-Express physical layer process means 811 and outputs the detected data amount to the data allocation means 613 (step S302). The data allocation means 613 allocates the PCI-Express packet inputted from the wiring paths 610-1 to 610-M to the optical transmitters 615-1 to 615-N based on the data amount detected by the data amount detection means 612 and the transmission capacity of the optical transmitters 615-1 to 615-N (step S303). Because the operation of the data allocation is performed like the first exemplary embodiment as shown in FIGS. 8 to 10, the description will be omitted.

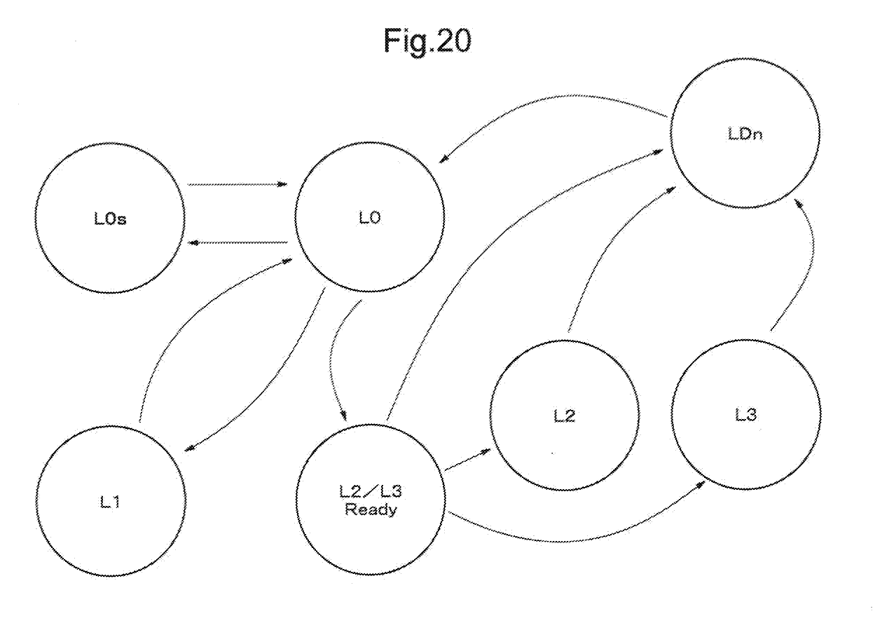

Next, the power state detection means 812 detects the power state of the PCI-Express physical layer process means 811 and notifies the optical transmitter power state switch means 813 of the detection result (step S304). A type and its content of the power state of the PCI-Express are the same as those explained in FIG. 20.

The optical transmitter power state switch means 813 changes the power state of the optical transmitters 615-1 to 615-N of the optical transmission paths 63-1 to 63-N to which the PCI-Express packet is not allocated (step S305). The power state is changed based on the allocation information to the optical transmitters 615-1 to 615-N that is received from the data allocation means 613 and the power state of the PCI-Express that is received from the power state detection means 813. For example, when the power state detected from the PCI-Express is “L2”, a clock and a main power supply of the optical transmitters 615-1 to 615-N to which the packet is not allocated are stopped. Further, for example, when the power state detected from the PCI-Express is “L3”, the supply of the power to the optical transmitter 615 to which the packet is not allocated is completely stopped.

The optical transmitter power state switch means 813 notifies the power state transmission means 814 of the power supply control information on the optical transmitters 615-1 to 615-N (step S306). Here, the power supply control information includes the allocation information to the optical transmitters 615-1 to 615-N and the power state detected from the PCI-Express. The power state transmission means 814 transmits the power supply control information on the optical transmitters 615-1 to 615-N to the power state reception means 822 of the reception process section 802 on the opposite side via the transmission path 64 (step S307).

On the other hand, the optical transmitters 615-1 to 615-N convert the electrical signal including the allocated PCI-Express packet into the optical signal and transmit it to the reception process section 62 on the opposite side via the optical transmission paths 63-1 to 63-N (step S308).

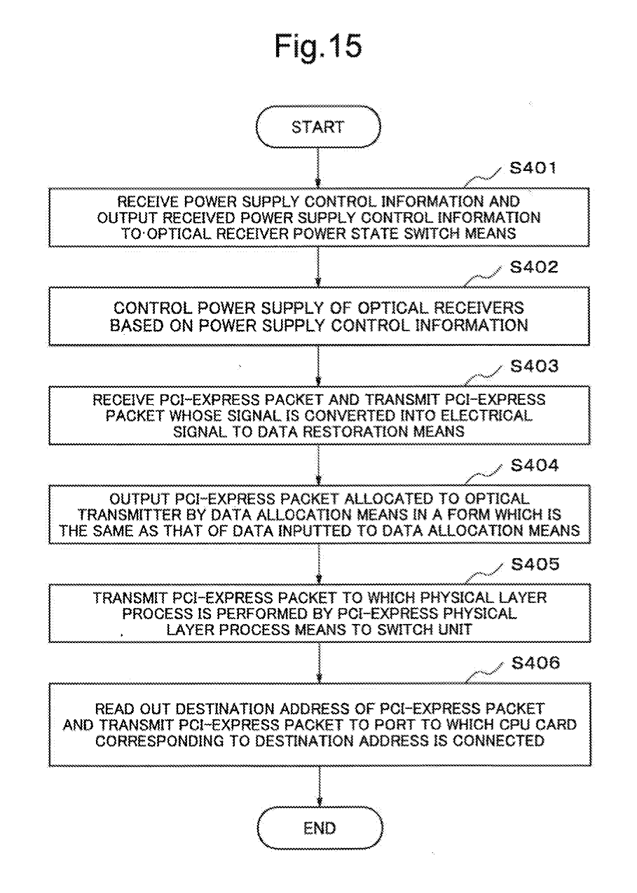

Next, the operation of the reception process section 802 will be described. FIG. 15 is a flowchart showing operation of the reception process section 802 of the second exemplary embodiment.

In the reception process section 802, the power state reception means 822 receives the power supply control information from the transmission path 64 and outputs the received power supply control information to the optical receiver power state switch means 821 (step S401).

The optical receiver power state switch means 821 controls the power supply of the optical receivers 621-1 to 621-N based on the power supply control information received from the power state transmission means 814 of the transmission process section 801 (step S402). The control to the optical receivers 621-1 to 621-N based on the power supply control information is the same as the control to the optical transmitters 615-1 to 615-N that has been explained concerning step S305 shown in FIG. 14. Namely, the optical receiver power state switch means 821 changes the power state of the optical receiver corresponding to the optical transmission path to which the PCI-Express packet is not allocated among the optical receivers 621-1 to 621-N based on the power supply control information.

The optical receivers 621-1 to 621-N receive the PCI-Express packet whose signal is converted into the optical signal and transmit the PCI-Express packet converted into the electrical signal to the data restoration means 622 (step S403).

The data restoration means 622 outputs the PCI-Express packet allocated to the optical transmitters 615-1 to 615-N by the data allocation means 613 in a form which is the same as that of the data inputted to the data allocation means 613 (step S404). Here, the operation of the data restoration means 622 in the second exemplary embodiment is the same as the operation of the data restoration means 622 in the first exemplary embodiment. Therefore, the explanation will be omitted.

The PCI-Express packet outputted from the data restoration means 622 is inputted to the PCI-Express physical layer process means 811 by the wiring paths 620-1 to 620-M. The PCI-Express physical layer process means 811 performs the physical layer process of the PCI-Express packet. The PCI-Express physical layer process means 811 transmits the PCI-Express packet to the switch unit 523 shown in FIG. 5 from the data output paths 601-1 to 601-M (step S405).

The switch unit 523 reads out the destination address of the PCI-Express packet and refers to the route table 522. The switch unit 523 transmits the PCI-Express packet to a port to which the CPU card corresponding to the read-out destination address is connected (step S406).

As a result, the PCI-Express packet is outputted from the switch card 22 to the CPU card 21 that is a desired destination. The transmission of the PCI-Express packet from the switch card 22 to the CPU card 21 is also performed by the same procedure mentioned above.

As mentioned above, in the intra-chassis optical communication system described in the second exemplary embodiment, the data allocation means 613 allocates the data to the optical transmitters 615-1 to 615-N so that the PCI-Express packet is transmitted by the smaller number of transmission paths according to the data amount of each transmission path of a parallel transmission path and the transmission capacity of the optical transmitter.

As a result, the intra-chassis optical communication system described in the second exemplary embodiment has an advantage that in the communication system using the parallel transmission, usage efficiency of the transmission path can be improved.

In the intra-chassis optical communication system described in the second exemplary embodiment, the power supply of the optical transmitter and the optical receiver that are connected to the transmission path to which the packet is not allocated can be controlled according to the power state of the PCI-Express.

Namely, the intra-chassis optical communication system of the second exemplary embodiment has an advantage that low power consumption can be realized.

In the first exemplary embodiment and the second exemplary embodiment, a configuration in which the transmission path different from the optical transmission paths 63-1 to 63-N is used as the transmission path 64 for transferring the power supply control information on the optical transmitter from the optical transmitter to the optical receiver has been described. As an example of modification to these exemplary embodiments, a configuration in which the power supply control information is superimposed on the data transmitted by the optical transmission paths 63-1 to 63-N and transmitted can be realized. This modification example has an advantage that more efficient use of the transmission path can be achieved because it is not necessary to separately provide a transmission path for transferring the power supply control information.

Furthermore, the power supply control described in the first exemplary embodiment in which the control is achieved based on only a situation of data allocation to the optical transmitter and the power supply control described in the second exemplary embodiment in which the control is achieved based on the power state of the PCI-Express may be used concurrently. In this case, the power supply control having a priority may be set to the optical transmitter and the optical receiver in advance. Alternatively, a determination means for determining the power supply control to be prioritized and outputting it may be provided so that according to a determination result of the determination means, the power supply of the optical transmitter and the optical receiver are controlled by any one of the power supply control achieved based on a situation of data allocation to the transmission path and the power supply control achieved based on the power state.

Further, the operation described in the flowchart explained in FIG. 14 and FIG. 15 may be controlled by the CPU 650 included in the transmission process section 801 or the CPU 660 included in the reception process section 802 by using a program.

### Third Exemplary Embodiment

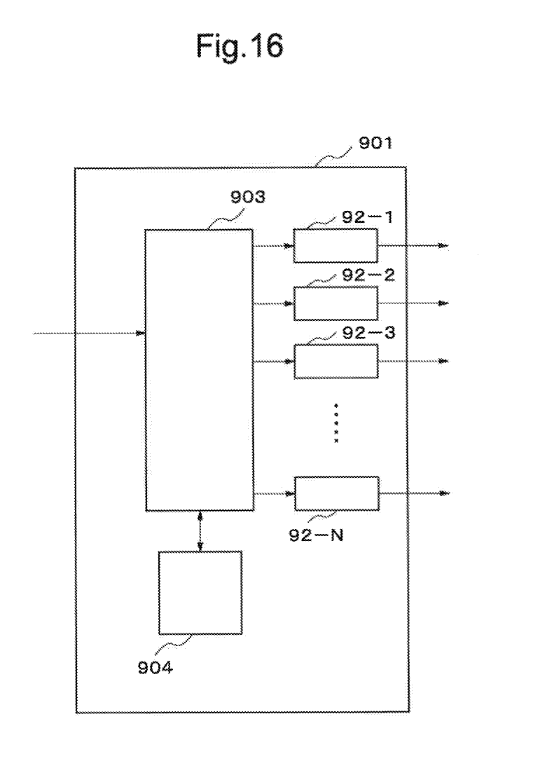

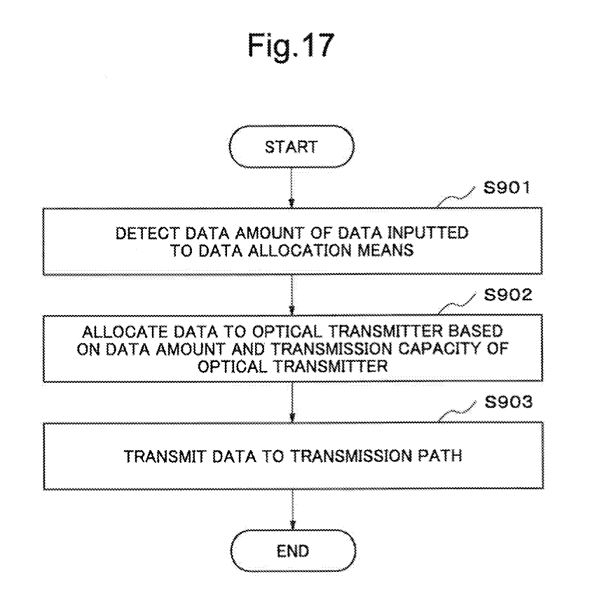

FIG. 16 is a figure showing a configuration of a transmission device of a third exemplary embodiment of the present invention. FIG. 17 is a flowchart showing operation of the transmission device of the third exemplary embodiment.

A transmission device 901 includes N transmission means 92-1 to 92-N for transmitting data, a data allocation means 903 for allocating data to the transmission means 92-1 to 92-N, and a data amount detection means 904 for detecting a data amount of data inputted to the data allocation means 903.

Here, N is a natural number of two or more.

The operation of the transmission device 901 will be described by using FIG. 17.

The data amount detection means 904 detects the data amount of data inputted to the data allocation means 903 from the outside of the transmission device 901 (step S901). The data allocation means 903 allocates the data to the transmission means 92-1 to 92-N based on the detected data amount and the transmission capacity of the transmission means (step S902). The transmission means 921 to 92N transmit the data allocated by the data allocation means 904 (step S903).

Here, the data allocation means 904 allocates the data to the transmission means so that the number of transmission means to be used becomes smaller based on the detected data amount and the transmission capacity of the transmission means.

As a result, the transmission device of the third exemplary embodiment has an advantage that in the communication system using the parallel transmission, efficient use of the transmission path can be achieved.

### Fourth Exemplary Embodiment

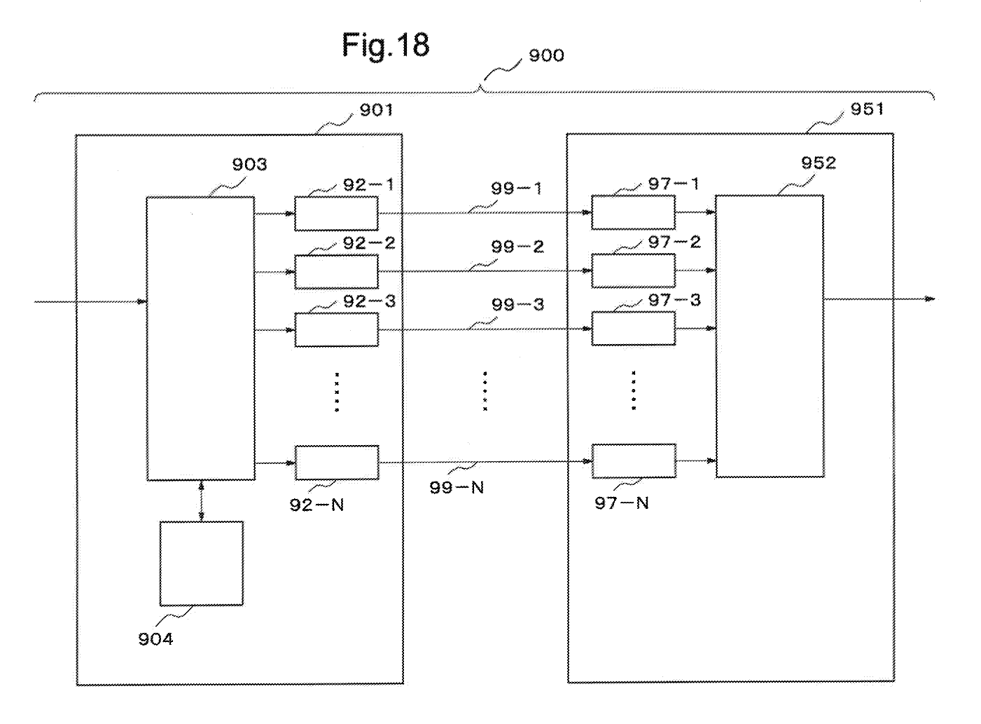

FIG. 18 is a figure showing a configuration of a communication system of a fourth exemplary embodiment of the present invention. In a communication system 900, the transmission device 901 is connected to a reception device 951 via a plurality of transmission paths 99-1 to 99-N. Here, N is a natural number of two or more.

The transmission device 901 in the fourth exemplary embodiment is the same as the transmission device 901 explained by using FIG. 16 and FIG. 17 in the third exemplary embodiment. Therefore, explanation of the configuration and the operation thereof will be omitted.

The reception device 951 includes N reception means 97-1 to 97-N and data restoration means 952.

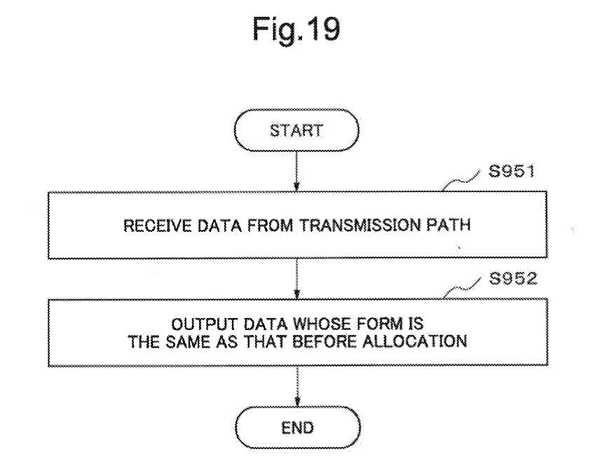

FIG. 19 is a flowchart showing operation of a reception device in a communication system of the fourth exemplary embodiment. The operation of the reception device 951 will be described by using FIG. 19.

The reception means 97-1 to 97-N receive data from the transmission paths 99-1 to 99-N (step S951). The data restoration means 952 outputs the data received by the reception means 97-1 to 97-N in a form which is the same as that of the data inputted to the data allocation means 904 (step S952).

Namely, the communication system of the fourth exemplary embodiment shown in FIG. 18 allocates the data to the transmission means so that the number of transmission paths to be used becomes smaller in the transmission means based on the data amount and the transmission capacity of the transmission means. The reception device 951 including the reception means 97-1 to 97-N and the data restoration means 952 outputs the data allocated to the transmission means in a form that is the same as that before allocation.

As a result, the communication system and the reception device described in FIG. 18 have an advantage that in a communication system using the parallel transmission, more efficient use of the transmission path can be achieved.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2009-104749, filed on Apr. 23, 2009, the disclosure of which is incorporated herein in its entirety by reference.

### DESCRIPTION OF SYMBOL

2 chassis

200 intra-chassis optical communication system

21 CPU card

22 switch card

311 optical connector

312 power supply connector

313 electrical connector

32 optical backplane

321 optical connector

322 optical fiber

33 electrical backplane

331 electrical connector

332 power supply connector

41 CPU card slot

42 switch card slot

511 CPU

512 memory unit

513 north bridge unit

514 I/O unit

515 south bridge unit

521 I/O unit

522 route table unit

523 switch unit

61 transmission process section

600-1 to 600-M data input path

601-1 to 601-M data output path

610-1 to 610-M wiring path

611 Ethernet protocol process means

612 data amount detection means

613 data allocation means

614 data process means

615-1 to 615-N optical transmitter

616 optical transmitter switch means

617 switch information transmission means

62 reception process section

620-1 to 620-M wiring path

621-1 to 621-N optical receiver

622 data restoration means

623 optical receiver switch means

624 switch information reception means

63-1 to 63-N optical transmission path

64 transmission path

650 CPU

651 memory

660 CPU

661 memory

801 transmission process section

811 PCI-Express physical layer process means

812 power state detection means

813 optical transmitter power state switch means

814 power state transmission means

802 reception process section

821 optical receiver power state switch means

822 power state reception means

900 communication system

901 transmission device

903 data allocation means

904 data amount detection means

92-1 to 92-N transmission means

951 reception device

952 data restoration means

97-1 to 97-N reception means

99-1 to 99-N transmission path

1-24. (canceled)

25. A transmission device comprising:
a data amount detection unit for detecting a data amount of inputted data;
a plurality of transmission units for transmitting the data in parallel; and
a data allocation unit for allocating the inputted data to the transmission unit selected from the plurality of transmission units based on the data amount and a transmission capacity of the transmission units.

26. The transmission device according to claim 25 wherein the inputted data is inputted to the data amount allocation unit from a single input path.

27. The transmission device according to claim 25 wherein the inputted data is inputted to the data amount allocation unit in parallel, and wherein the number of the inputted data is equal to the number of the transmission units.

28. The transmission device according to claim 25, further comprising:
a transmitter switch unit for generating a first power supply control information based on a situation of data allocation to the transmission unit and controlling a power supply of the transmission unit based on the first power supply control information; and
a control information transmission unit for transmitting the first power supply control information.

29. The transmission device according to claim 28 wherein the transmitter switch unit stops the supply of the power to the transmission unit to which the data is not allocated based on the first power supply control information.

30. The transmission device according to claim 25, further comprising:
a power state detection unit for detecting a power supply state (power state) that is defined in a protocol for transmitting the data;
a transmitter power state switch unit for generating a second power supply to control information based on the power state and the situation of data allocation to the transmission unit and controlling a power supply of the transmission unit based on the second power supply control information; and
a power state transmission unit for transmitting the second power supply control information.

31. The transmission device according to claim 30 wherein the transmitter power state switch unit stops the supply of the power to the transmission unit to which the data is not allocated based on the second power supply control information.

32. A reception device comprising:
a reception unit for receiving the data from the transmission device according to claim 25; and
a data restoration unit for outputting the received data in a form which is the same as that of the data inputted to the data allocation unit.

33. A reception device comprising:
a reception unit for receiving the data from the transmission device according to claim 26; and
a data restoration unit for outputting the received data from a single output.

34. A reception device comprising:
a reception unit for receiving the data from the transmission device according to claim 27; and
a data restoration unit for outputting the received data in parallel, wherein the number of the outputted data is equal to the number of the transmission units.

35. A reception device comprising:
a reception unit for receiving the data from the transmission device according to claim 28;
a data restoration unit for outputting the received data in a form which is the same as that of the data inputted to the data allocation unit;
a control information reception unit for receiving the first control information from the transmission device; and
a receiver switch unit for controlling a power supply of the reception unit based on the first power supply control information.

36. The reception device according to claim 35 wherein the receiver switch unit stops the supply of the power to the reception unit connected to the transmission unit to which the data is not allocated.

37. A reception device further comprising:
a reception unit for receiving the data from the transmission device according to claim 30;
a data restoration unit for outputting the received data in a form which is the same as that of the data inputted to the data allocation unit included in the transmission device;
a power state reception unit for receiving the second power supply control information; and
a receiver power state switch unit for controlling a power supply of the reception unit based on the second power supply control information.

38. The reception device according to claim 37 wherein the receiver power state switch unit stops the supply of the power to the reception unit connected to the transmission unit to which the data is not allocated.

39. A communication system comprising the transmission device and the reception device according to claim 32 through a transmission path, wherein the transmission device comprises:
a data amount detection unit for detecting a data amount of inputted data;
a plurality of transmission units for transmitting the data in parallel; and
a data allocation unit for allocating the inputted data to the transmission unit selected from the plurality of transmission units based on the data amount and a transmission capacity of the transmission units.

40. A transmission method comprising the steps of:
detecting a data amount for detecting a data amount of inputted data;
allocating the data to transmission unit selected from a plurality of transmission units based on the data amount and a transmission capacity of the transmission units; and
transmitting the inputted data in parallel by using the selected transmission unit.

41. The transmission method according to claim 40, further comprising allocating the data inputted from a single input to the selected transmission unit.

42. The transmission method according to claim 40, further comprising allocating the data inputted from an input with parallel inputs, wherein the number of parallel inputs is equal to the number of the transmission units, to the selected transmission unit.

43. A reception method comprising the steps of:
receiving the data transmitted by using the transmission method according to claim 40; and
outputting the received data in a form which is the same as that of data before being allocated to the transmission unit.

44. A computer-readable recording medium for recording a control program for a transmission device that allows the transmission device to operate, the operations comprising:
a data amount detection unit for detecting a data amount of inputted data;
a plurality of transmission units for transmitting the data in parallel, and
a data allocation unit for allocating the inputted data to the transmission unit selected from the plurality of transmission units based on the data amount and a transmission capacity of the transmission unit.
